(19) United States
(12) Patent Application Publication
(10) Pub. No.: US 2018/0302753 A1
(43) Pub. Date: Oct. 18, 2018

(54) Tracking Device, Apparatus and System

(71) Applicant: Pod Trackers Pty Ltd, New South Wales (AU)

(72) Inventor: Sebastian Ralph Edward Langton, North Sydney, New South Wales (AU)

(21) Appl. No.: 15/739,365

(22) PCT Filed: Jun. 27, 2016
(86) PCT No.: PCT/AU2016/050549

§ 371 Date: Jun. 15, 2018

(30) Foreign Application Priority Data
Jun. 26, 2015 (AU) 2015203592

(51) Int. Cl. H04W 4/029

(52) U.S. Cl. CPC H04W 4/029; G01S 19/13

(57) ABSTRACT

The present invention relates to a tracking system comprising a tracking device. The tracking device in the form of a barrel-shaped unit contains geo-location circuitry and communications circuitry. The unit has curved surfaces to avoid irritating an item being tracked, such as a pet or to conveniently attach to an item being tracked i.e. bike. A mounting structure of the internal circuitry braces the walls of the unit, to provide a robust structure and efficient use of the space. A battery is provided, which can be removed and replaced without removal of the tracking device from the item being tracked. A strapping arrangement is provided to mount the device to the item being tracked. The device interfaces with remote software in the form of an application or webpage, to enable users to establish the location of the tracking device and perform other functions such as tracking activity levels.

### FIELD OF THE INVENTION

The present invention relates to a tracking device, tracking apparatus and tracking system, and particularly, but not exclusively, to a tracking device, apparatus and system arranged for tracking items, such as pets, children, the elderly, cars, boats, bikes, luggage etc.

### BACKGROUND OF THE INVENTION

It is desirable to be able to track the location of items, such as pets, for example. Pets often stray. Although pets are “micro-chipped” in many countries, this only enables them to be identified when found. It does not enable location when they are lost.

Tracking devices are known which enable the location of pets to be established. Current functionality and design is limited, however.

### SUMMARY OF INVENTION

In accordance with a first aspect, the present invention provides a tracking device, comprising circuitry and a housing mounting the circuitry, the circuitry comprising tracking circuitry arranged to provide location data enabling identification of a location of the tracking device, and communications circuitry arranged to communicate the location data, the housing comprising housing walls forming an enclosure, the circuitry being mounted within the enclosure, the housing walls having a curved form.

In an embodiment, the housing walls form a cylindrical enclosure. The tracking device may be mounted to an item to be tracked, such as a pet, person, boat, bike, luggage, or any other item. It is an advantage of at least an embodiment that the curved, cylindrical form of the device enables it to be unobtrusively mounted at a convenient position with respect to the item. If fitted on a pet or a human being, the curved form of the housing facilitates comfort and reduces the potential for irritation. The device may be unobtrusively fitted where convenient.

In an embodiment, the housing walls comprise a mounting portion arranged for enabling mounting of the device with respect to the item to be tracked.

In an embodiment, a plurality of channels are provided in the mounting portion of the housing walls, for receiving parts of a fastener, for fastening the device to an item.

In an embodiment, the fastener is an adjustable strap. In an embodiment, the adjustable strap comprises a central strap portion and two prong portions. In use, the central strap portion passes between the two prong portions. The prong portions and the central strap pass through the channels on the device. The arrangement securely mounts the device, and resists twisting or turning of the device.

In a further embodiment, a fastener comprises an adjustable strap, comprising a single strap portion. The strap is relatively broad. When in position, the relatively broad strap resists twisting or turning of the device. The single strap is relatively easy to secure. In this embodiment, a single channel is provided in the mounting portion of the housing walls, for receiving the strap.

In an embodiment, the circuitry is mounted by a mounting structure arranged within the housing and arranged to operate to brace the housing walls, whereby to strengthen the device.

In an embodiment, the mounting structure comprises one or more printed circuit boards (PCBs), at least one of the PCBs being positioned transversely to a longitudinal axis of the housing structure. The PCB may extend across the width of the enclosure formed by the housing walls, abutting the housing walls and bracing the structure.

In an embodiment, there are a plurality of PCBs mounting the circuitry. One or more of them may be placed transversely and one or more other PCBs may run longitudinally with respect to the housing. The PCBs that run longitudinally with respect to the housing may also extend across the housing to provide further bracing of the housing walls.

Advantageously, this arrangement of the circuitry mounting structure optimizes the use of the internal space of the enclosure. This enables the size of the device to be optimized, for discreet placement on the item being tracked.

In an embodiment, the device comprises a power supply comprising a battery mounted within the housing. In an embodiment, the battery is removable, so that it may be exchanged for a replacement battery, for example. The battery may be rechargeable.

Having a removable and replaceable battery advantageously enables the tracking device to operate continuously. The tracking device does not need to be removed from the item being tracked.

In an embodiment, the battery is mounted at one end of the housing. In an embodiment, a housing end portion where the battery is mounted may be removable from the rest of the housing, together with the battery. A replacement battery may comprise a replacement housing end portion mounting the replacement battery, which can fit to the rest of the housing with the replacement battery.

In an embodiment, the power supply may be delivered from an external source outside of the housing such as a car battery.

In an embodiment, the tracking device is arranged to implement a forced notification operation, to provide a forced notification to a processing apparatus which is in proximity to the tracking device. In an embodiment, the forced notification may comprise identification data of the tracking device or of the item being tracked. It may also comprise connection data enabling the processing apparatus to connect with the tracking device to upload further data. The further data may include identity of the item associated with the tracking device and ownership of the item, or any other data. The processing apparatus may be a mobile device, such as a smart phone, tablet or the like.

In an embodiment, the circuitry also comprises wireless circuitry, able to implement Wi-Fi or similar technology. In an embodiment, the Wi-Fi technology is used for location of the tracker via Wi-Fi networks and triangulation. In an embodiment, where other location circuitry, such as a GPS chip or a mobile/cellular chip is included, the wireless circuitry can facilitate the location operation, making it more robust.

In an embodiment, where wireless circuitry is included, it may not be necessary to include any other location technology or any other communications circuitry. In this embodiment the tracking device can be located by sending a message to the device via Wi-Fi or similar technology and the device responds with an acknowledgement which confirms that the tracking device is within range of a particular Wi-Fi network, with a known physical location. This therefore provides an approximate location of the device, routed to the known Wi-Fi network's location. For example, this could quickly confirm that the tracking device is at home if it is connected to the user's home Wi-Fi network. This would be a less expensive embodiment and wouldn't necessarily require a GPS chip or a mobile/cellular chip and SIM card.

In accordance with a second aspect, the present invention provides a tracking device, comprising circuitry and a housing mounting the circuitry, the circuitry comprising tracking circuitry arranged to provide location data enabling identification of the location of the tracking device, and communications circuitry arranged to communicate the location data, the housing comprising housing walls forming an enclosure, the circuitry being mounted within the enclosure, the circuitry being mounted by a mounting structure arranged to brace the housing walls, whereby to strengthen the device.

In an embodiment, the mounting structure comprises one or more PCBs, at least one of the PCBs being placed transversely to a longitudinal axis of the housing.

In an embodiment there are a plurality of PCBs, one or more may be placed transversely and one or more may be placed longitudinally with respect to the housing. In an embodiment, the one or more longitudinal mounted PCBs may also extend across the internal space of the housing to abut and further brace the walls of the housing.

In an embodiment, the transverse and longitudinal PCBs are mounted to optimize the volume within the housing available for mounting circuitry.

This second aspect of the invention may have any or all of the features of the first aspect of the invention.

In accordance with a third aspect, the present invention provides a tracking device, comprising circuitry and a housing mounting the circuitry, the circuitry comprising tracking circuitry arranged to provide location data enabling identification of the location of the tracking device, and communications circuitry arranged to communicate the location data, the housing comprising housing walls forming an enclosure, the circuitry being mounted within the enclosure, and a power supply, in the form of a removable battery, removably mounted within the enclosure.

In an embodiment, the battery can be removed and replaced with a replacement battery, to enable the tracking device to continue operating without it being necessary to remove it from the item being tracked.

In an embodiment, the housing is in two parts, one part containing the battery. The one part containing the battery may be removable from the rest of the housing in order to remove the battery. A replacement battery may be mounted within a replacement housing part, which substitutes for the one part removed.

This third aspect of the invention may incorporate any or all of the features of the first and second aspects of the invention.

In accordance with a fourth aspect, the present invention provides a tracking device, comprising circuitry and a housing mounting the circuitry, the circuitry comprising tracking circuitry arranged to provide location data enabling identification and location of the tracking device, and communication circuitry arranged to communicate the location data, the housing comprising housing walls forming an enclosure, the circuitry being mounted within the enclosure, the housing walls comprising a mounting portion arranged for enabling mounting of the device with respect to the item to be tracked, one or more channels provided in the mounting portion of the housing walls, for receiving a fastener, for fastening the device to an item.

In an embodiment, the fastener is an adjustable strap.

In an embodiment, there are a plurality of channels provided in the mounting portion of the housing walls, and the adjustable strap comprises a central strap portion and two prong portions. In an embodiment, the prong portions and the central strap pass through the channels on the device, to securely mount the device, and resist twisting or turning of the device.

In another embodiment, there is a single channel provided in the mounting portion of the housing walls, and the adjustable strap comprises a single strap portion. The single strap portion is relatively broad, in order to resist twisting or turning of the device.

This fourth aspect of the invention may incorporate any or all of the features of the first, second or third aspects of the invention.

In embodiments of the first to fourth aspects of the invention, communications apparatus may transmit the location data to a remote location, where it may be processed to provide tracking information. In one embodiment, the location data is processed by a geo-location process which enables identification of a geographical location of a tracking device. The geo-location may be presented on a map, for example.

The location data may include time data, identifying what time the location data was generated, so that the time at which the tracking device was at a particular location can be established.

The location data may be processed by a tracking apparatus, to present information on the location of the tracking device to a user. The tracking apparatus may comprise a computing apparatus, including a processor, memory and display. In an embodiment, it may comprise a mobile computing apparatus, such as a tablet, smartphone, watch, glasses or other portable/wearable technology. The tracking apparatus may also comprise a server which monitors communications from all tracking devices in the field. The server(s) may be housed in the “cloud”. The server may process location data for each tracking device, and provide tracking information to a website (for browsing by a user device), or to a computer application, such as an application on a mobile device.

In accordance with a fifth aspect, the present invention provides a tracking apparatus, comprising a processor, a memory, an interface, and a geo-location process arranged to receive location data from a tracking device, and to provide geo-location information identifying the geographical location of the tracking device.

In an embodiment, the geo-location information is provided by the interface. The interface may be a display. The interface may be a webpage served to a browser. The interface may comprise an application on a computing device (such as a smartphone, PC, laptop, tablet or other computing device).

The geo-location process may be a process which analyses the location data and provides geographical location information. In an embodiment, the location data may already be in the form of geographical location information, and the geo-location process of the tracking apparatus may merely forward the geographical location information to the interface. In an embodiment, the geo-location process may interface with a map visualization process to generate a map via the interface so that the user can visualize the geographical location of the tracking device.

In an embodiment, the map may include 3D map visualizations from various sources including satellite imagery and aircraft photography.

In an embodiment, the location data includes time data, providing information on the time the location data was obtained. The geo-location process may be arranged to provide information on geographical location at any time. It may provide real time location information, showing the last known location (current location). In an embodiment, the tracking apparatus is arranged to store historical location data. The historical location data may be presented via the interface. In this way, a user may view the location of the tracking device over time.

In an embodiment, the apparatus comprises an activity tracking process, which is arranged to determine activity data of the tracking device. The activity data may include speed of travel of the tracking device, distance travelled and other activity data. Advantageously, this enables a user to determine the activity of an item being tracked e.g. what speed it is travelling, what distance it has travelled. A user could track the activity data of a pet, for example.

In an embodiment, the apparatus is arranged to store activity data in the memory. Activity data may be partitioned in dependence on time, place or other partitioning. A user may be able to retrieve and view activity data e.g. activity during particular times, or in a particular geographical area.

In an embodiment the apparatus further comprises a boundary monitoring process. The boundary monitoring process may enable a user to set a boundary, or may automatically set a boundary. The process enables a user to determine when a boundary has been breached. For example, a circular or polygonal boundary may be set around a location. If the boundary is breached, the boundary tracking process is arranged to provide an alert, in an embodiment, so that a user is aware that the boundary has been breached.

In an embodiment, the apparatus comprises a battery monitoring process. This is arranged to receive battery data from a tracking device and advise a user via the interface, of the battery level. A user can therefore be alerted that a battery of the tracking device needs to be changed.

In an embodiment, the apparatus comprises an associated device detection process, which is arranged to receive data regarding an associated device. The associated device may be a further tracking device. The further tracking device may be used to track another item. The associated device detection process may determine a time period that the tracking device and associated device spend in a predetermined proximity to each other.

In an embodiment, the tracking apparatus includes a social network process enabling information on the tracking device to be uploaded to a social network. The information may include activity data, data on an associated device, historical location data, profile data, social data and any other data produced by the tracking apparatus, tracking device or the relationship between users and/or tracking devices.

The tracking device may comprise the tracking device of any of the first, second and third aspects of the invention.

In accordance with a sixth aspect, the present invention comprises a tracking system, comprising a tracking device in accordance with any one of the first to fourth aspects of the invention, and a tracking apparatus in accordance with the fifth aspect of the invention.

In accordance with a seventh aspect, the present invention provides a computer program, comprising instructions for controlling a computer to implement a tracking apparatus in accordance with the fifth aspect of the invention.

The computer may be a server, a mobile device, smartphone, PC or any other type of computing apparatus.

In accordance with an eighth aspect, the present invention comprises a computer readable medium providing a computer program in accordance with the seventh aspect.

In accordance with a ninth aspect, the present invention provides a data signal, comprising a computer program in accordance with the seventh aspect.

### BRIEF DESCRIPTION OF THE FIGURES

Features and advantages of the present invention will become apparent from the following description of embodiments thereof, by way of example only, with reference to the accompanying Drawings, in which;

FIG. 1 is a perspective view from below and one end of a tracking device in accordance with an embodiment of the present invention;

FIG. 2 is a perspective view from below and the other end of the device of FIG. 1, showing an end portion of the device separated from a main body of the device;

FIG. 3 is a further view of the end portion of the device of FIG. 2, showing battery and terminals;

FIG. 4 is a side view from one side of the device of FIG. 1;

FIG. 5 is a view from the bottom of the device of FIG. 1;

FIG. 6 is a plan view of a fastener for securing the device of FIG. 1 to an item to be tracked;

FIG. 7 is a perspective view of the device of FIG. 1, illustrating the fastener of FIG. 6 in use;

FIG. 8 is a longitudinal cross-section through the device of FIG. 1, illustrating internal components;

FIG. 8a is a perspective view from below of the device of FIG. 1, showing a portion of the device cut away to show the internal structure;

FIG. 8b is a plan view of a circuit board mounted in the housing of FIG. 8a;

FIG. 9 is a block schematic diagram of the circuitry of the device of FIG. 1;

FIG. 10 is a perspective view showing an embodiment of a charging station for use with the battery of FIG. 3;

FIG. 11 is a schematic block diagram of an example computing system which may be utilised to implement a tracking apparatus in accordance with an embodiment of the invention;

FIG. 12 is a schematic diagram illustrating operation of a system in accordance with an embodiment of the invention;

FIGS. 13 to 20 are example displays which may be rendered by an interface of a tracking apparatus in accordance with an embodiment of the invention and

FIG. 21 is a perspective view from one side and above of a tracking device in accordance with an embodiment of the invention, shown secured to a collar by an alternative fastening device;

FIG. 22 shows a perspective view from above of the alternative fastening device of FIG. 21;

FIG. 23 is a perspective view from below and one side of the arrangement of FIG. 21;

FIG. 24 is a perspective view of the tracking device of FIG. 21, from below, illustrating a channel for securing the fastening device, and

FIG. 25 is a view of the tracking device from the side, further illustrating the channel.

### DETAILED DESCRIPTION OF EMBODIMENTS OF THE INVENTION

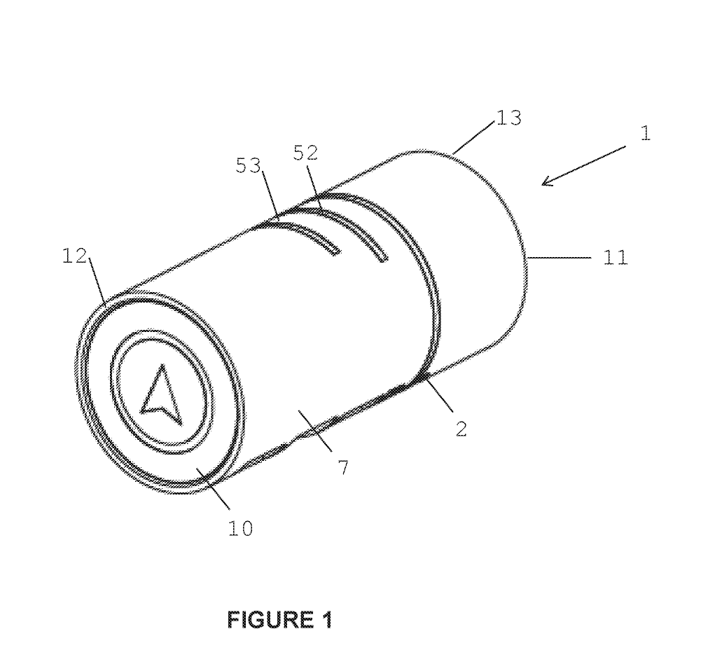

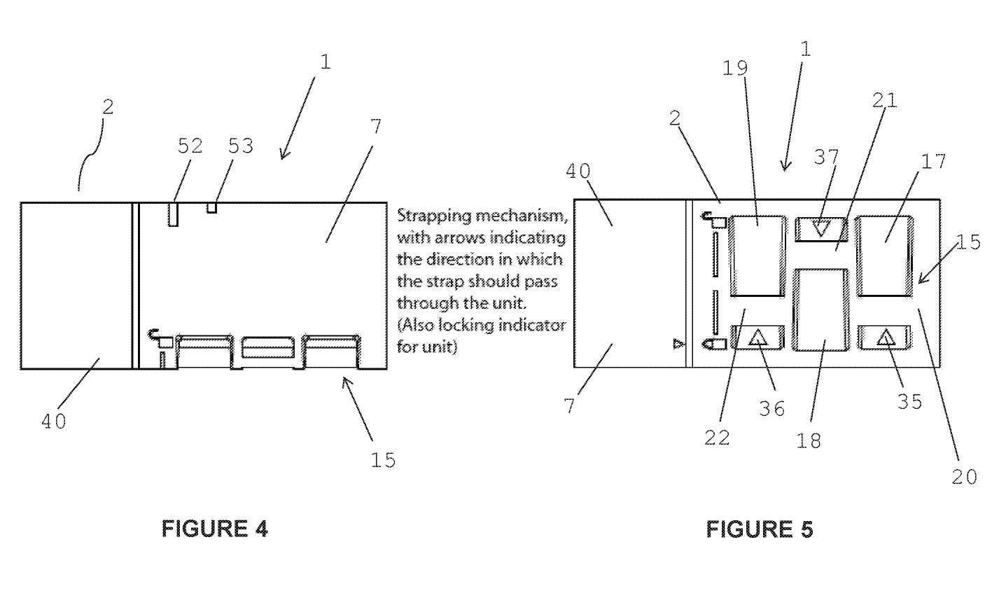

FIGS. 1 through 9 show a tracking device in accordance with the one embodiment of the present invention, generally designated by reference numeral 1. The device comprises circuitry, generally designated by reference numeral 3 and a housing 2. The circuitry in this example comprises tracking circuitry 4 and communications circuitry 5, 6.

The tracking circuitry 4 is arranged to provide location data and the communications circuitry 5, 6 is arranged to communicate the location data to remote locations. In this example embodiment, the tracking circuitry 4 comprises a GPS unit and a WiFi unit 4. The communications circuitry comprises Bluetooth circuitry 5 and also mobile/cell telecommunications circuitry 6.

In another embodiment, the circuitry 3 could also include other components such as a compass, gyro sensor, thermometer, heart rate monitor, camera etc.

The location data may be provided by the communications circuitry 5, 6 to a remote location, so that the location of the tracking device can be established and monitored.

The housing 2 is formed by housing walls 7 that are of curved form. In this example, the housing wall 7 forms a cylindrical housing, having a circular lateral cross-section.

The curved form of the housing 2 facilitates unobtrusively mounting the device to the item to be tracked. Where the item is a pet, for example, the device may be mounted on the collar of the pet, by their neck, underneath their chin. The curved housing walls 7 facilitate comfort (minimized sharp edges) and reduce the potential for irritation.

The cylindrical cross-section need not be circular. In other embodiments, other cross-sections may be formed. For example, the cross-section could be oval to form an oval cross-sectional cylinder, pill shaped, square with rounded corners or rectangular with rounded corners. Other curved forms may be implemented.

The ends 10, 11 of the device are substantially flat, in this embodiment. In other embodiments they could be curved, in a convex fashion or a concave fashion. The edges 12, 13 of the end portions 10, 11 may also be rounded.

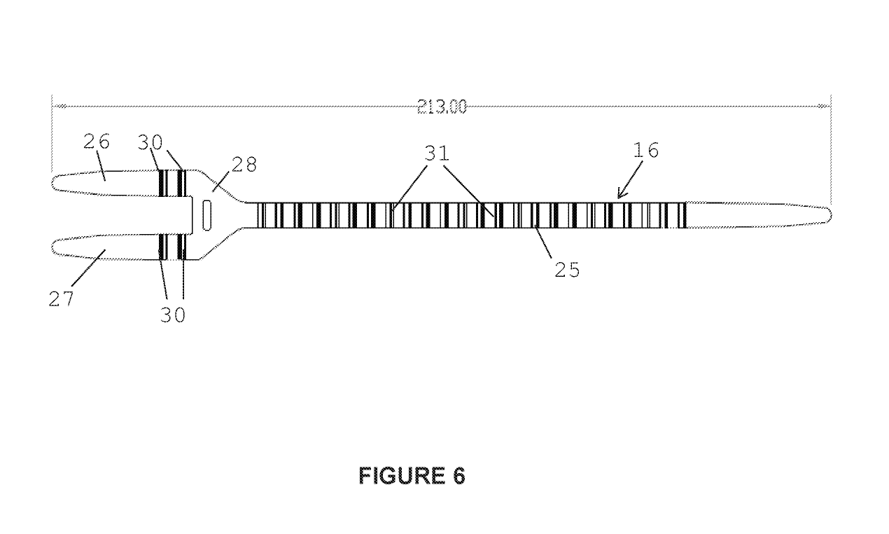

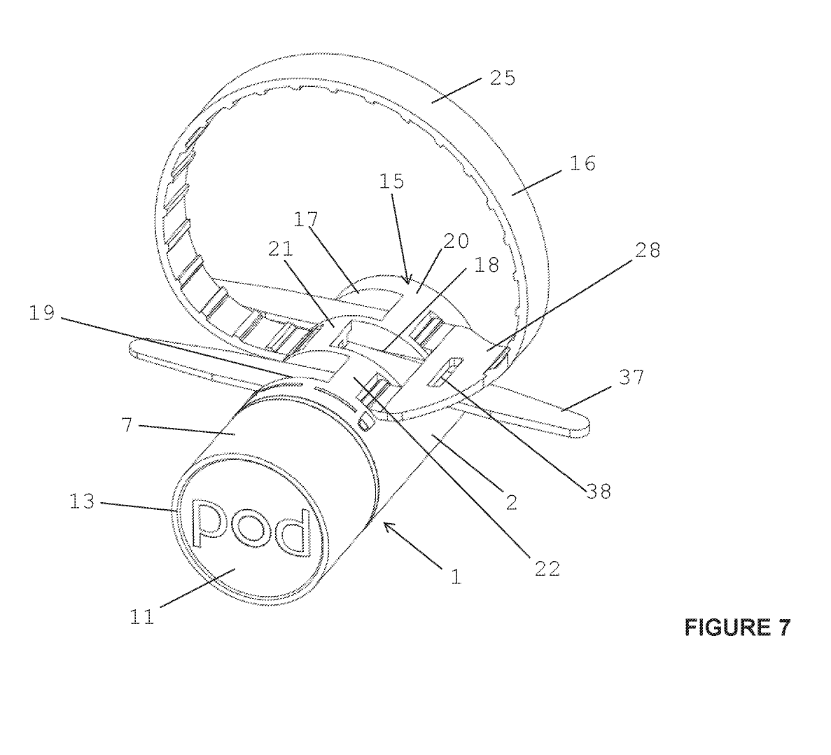

The housing 2 comprises a mounting portion 15 which is configured for receiving parts of a fastener 16 (FIG. 6 and FIG. 7) for securing the device 1 to an item to be tracked. In an embodiment, the mounting portion 15 of the housing 2 comprises three slots 17, 18, 19 in the housing 2. The slots 17, 18, 19 are partly covered by sections 20, 21, 22 of the housing wall 7, channels being formed by the slots 17, 18, 19 and housing portions 20, 21, 22.

The fastener 16 comprises an adjustable strap 16 having a central strap portion 25 and two prong portions 26, 27 extending in an opposite direction to the strap portion 25, the prongs 26, 27 are spaced laterally from each other. A base portion 28 of the fastener 16 mounts the strap 25 and prongs 26 and 27. The strap 25 can be passed back over the base portion 28 and through the gap between the prong portions 26 and 27.

As shown in FIG. 7, the prong portion 26 and 27 may be placed through channels 17 and 19. Projections 30 on the prong portion 26 and 27 interfere with the underside of the portions 20 and 22 to lock the prongs 26 and 27 in the channels 17 and 19. The strap portion is then passed over the base portion 28 and through the channel 18. The strap 25 is provided with a plurality of projections 31 which interfere with the underside of the portion 21 and can lock the strap 25 in place. There are a plurality of portions 31, so the extent of the strap 25 that passes into the channel 18 and is secured by part 21, is adjustable. Arrows 35, 36, 37 (FIG. 5) illustrate the direction in which the prongs 26, 27 and strap (25) should pass into the channels 17, 18, 19.

The strap 25 may be passed through a collar of a pet, for example. The prongs 26 and 27 positioned either side of the strap 16 when secured to the device 1, facilitate stability of the device. Twisting or turning of the device 1 is resisted.

A leading portion 37 of the strap 25 may be passed through a slot 38 in the base portion 28 so that it does not project and cause irritation. Alternatively, the portion 37 may be cut away. The ends of the prongs 26 and 27 can also be cut away to avoid them causing irritation.

In alternative embodiments, a Velcro arrangement may be used as a fastener. Other types of securing means and strap configurations may be used to secure the fastener. The strap may be of a different configuration. Rather than a strap and prongs, a single strap portion may be used. In this case a single channel (rather than a number of channels) may be provided in the housing.

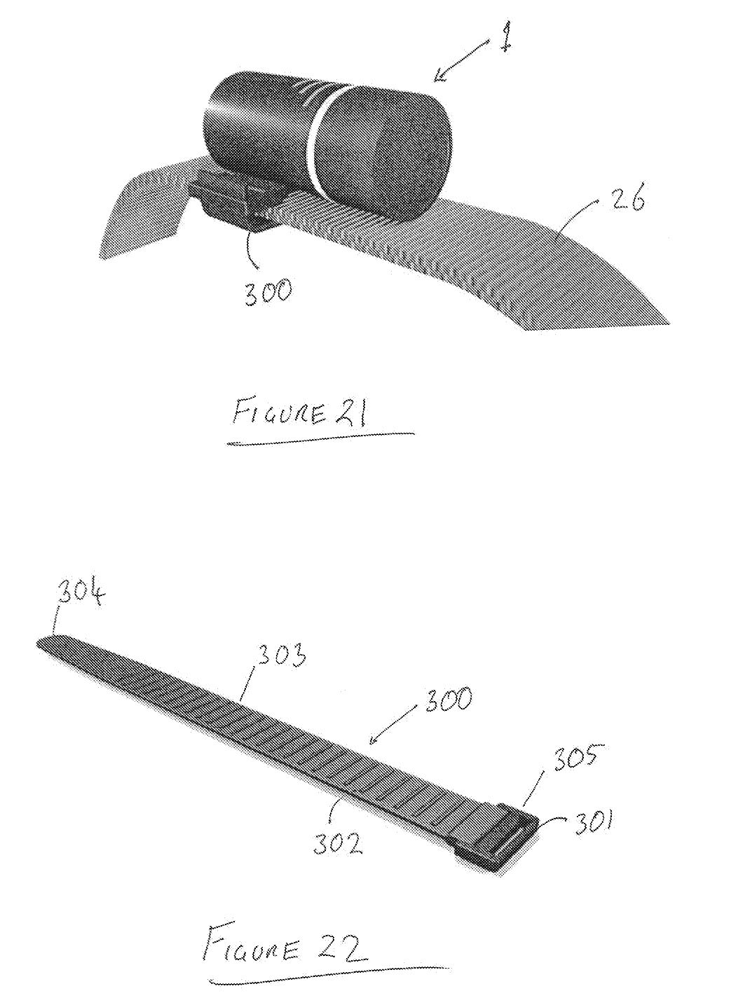

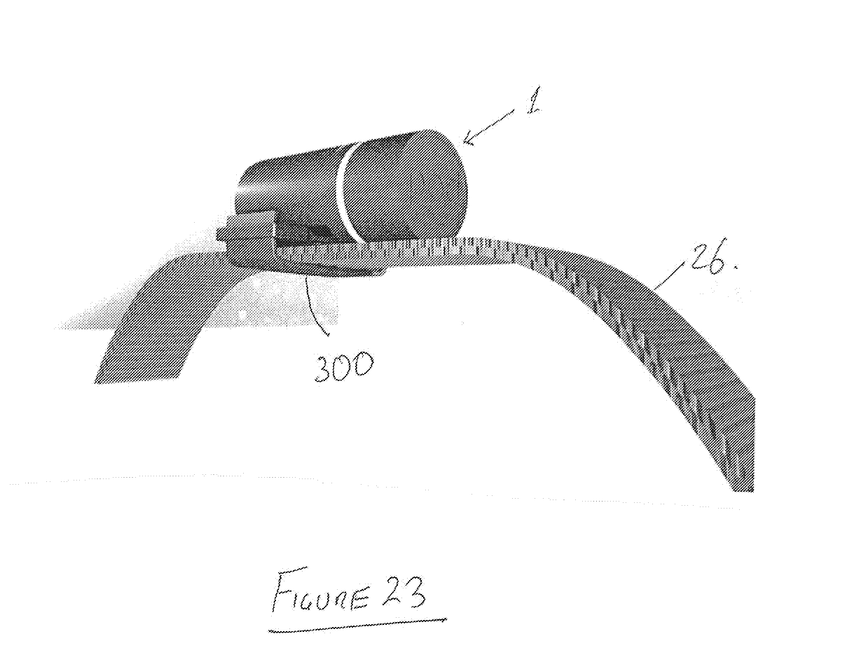

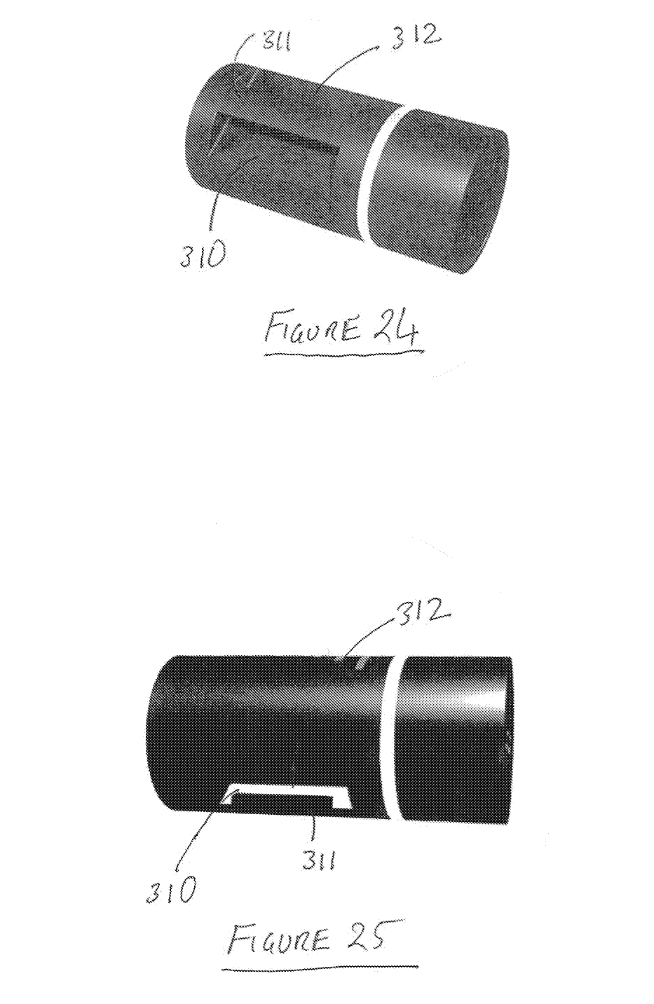

An alternative mounting arrangement is illustrated in FIGS. 21, 22 and 23. In this embodiment, a fastener 300 comprises a single strap arrangement 300, which is relatively broad. The strap 300 has a buckle portion 301 and a strap portion 302. The strap portion 302 is provided with projections 303 spaced along the strap portion 302. In operation, an end 304 of the strap portion 302 is passed through a slot 305 in the buckle portion 301. The projections interfere with the walls of the slot 305. The strap portion 302 is pulled tight through the buckle portion 301 (see FIG. 21 and FIG. 22). The projecting end 304 of the strap portion 302 may then be cut off (as shown in FIG. 21 and FIG. 23). In this manner the strap can be secured around a collar (reference numeral 306 in FIGS. 21 and 23). Strap portion 302 passes through a single channel 312 in the device 1 housing to secure the tracking device 1 to the collar 26 (or other webbing or arrangement to be secured to the item to be tracked (e.g. pet)). The channel is formed by a slot 310 in the housing 2 and an extending portion 311 which extends over the slot. The strap portion 302 is passed into the channel 312 and secured via the extending portion 311.

The strap portion 302 is relatively broad (particularly compared with the embodiments shown in FIGS. 6 and 7) and resists twisting or turning. It is also simpler to secure, as there is only a single strap portion 302. It may be made of plastics or rubber or any suitable material.

The strap portion may be anywhere between 10 and 40 mm broad; between 10 mm to 35 mm broad; between 10 mm to 30 mm or between 15 mm and 25 mm. It may be of any other dimension.

As a percentage of the housing length, the strap portion may be anywhere between 10 and 70% of the housing length, or between 15 and 60%; between 20 and 50%; between 25 and 40%; between 25 and 40%.

In other embodiments, mounting may be by different means. For example, the portion 15 of the housing may be flattened and adhesive or magnetic mountings may be utilised. A protective sleeve of soft elastic material may be used. A clamp-type mechanism may be used. Other connectors may be utilised.

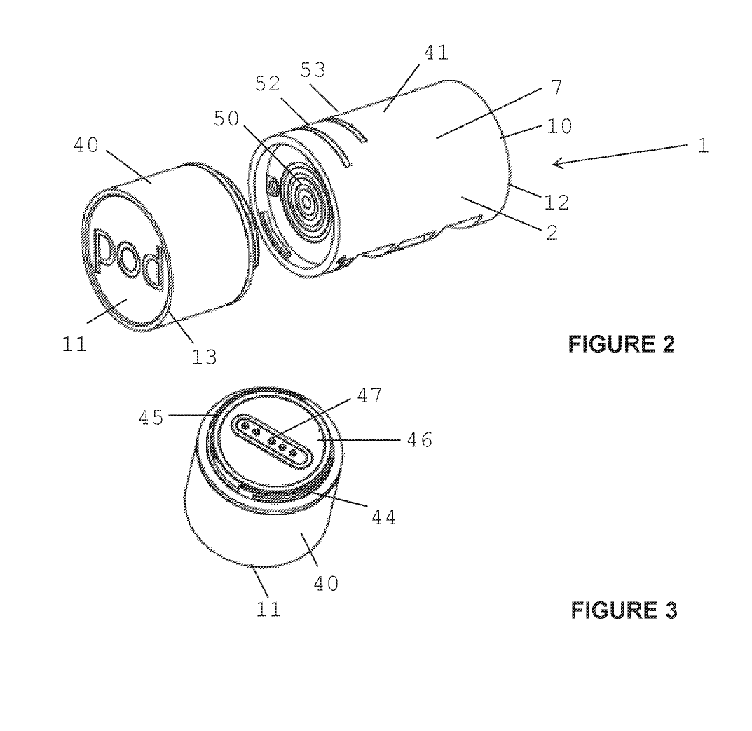

The housing 7 of this embodiment is separable into two parts. See FIGS. 2 and 3 in particular. A housing end portion 40 is removable from a main portion 41 of the housing. A twist and lock arrangement comprising lugs 42 and 43 on the main housing portion and projections 44 and 45 on the housing end portion 40 cooperate to secure end portion 40 and main portion 41 together. The projections 44 and 45 in operation sit behind lugs 42 and 43 via a twisting action to lock the projections 44 and 45 behind the lugs 42 and 43. To separate, the end portion 40 and main portion 41 are twisted relative to each other, so that the projections 44 and 45 move out from behind the lugs 42 and 43 and the parts 40 and 41 can be pulled apart.

The end portion 40 and main portion 41 are generally water proof or water resistant when secured together, preventing entry of water into the housing. Gaskets (not shown) may be provided on the end portion 40 and main portion 41 where they connect. A gasket may be provided about the projections 44, for example.

Referring to FIG. 5, locking indicator icons 300, 301 enable indication of when the end portion 40 is locked to and secured to the main portion 41. When the locked LED 302 is illuminated, next to the locked icon 300, the end portion 40 is secured. A further ‘arrow’ indicator 305 is provided on the end portion 40 to facilitate indication of locking. When this is lined up with the locking icon 300, the device is secured.

A battery 46 is mounted in the housing end portion 40. A power supply 48 comprises a battery connector PCB 48 and a battery PCB 49 which supports terminals 50 for connection with battery terminals 47. This provides power to the device 1. Circuitry may be provided on the power supply 48, 49 PCBs to provide a regulated power supply to the communications circuitry 5, 6 and tracking circuitry 4.

The battery 46 is therefore removable from the device 1 to be recharged. A replacement battery, with the same configuration as the battery illustrated, may be provided to connect to the device 1. The device 1 need not be removed from the item being tracked. A replacement battery is connected, and tracking can continue. The device 1 does not have to wait for recharge of a battery to operate again.

The battery PCB 49 also provides light emitting diodes 52, 53. When on, the LEDS, 52, 53 indicate that various features of the device are operating such as battery charge, mobile/cell reception and GPS lock.

A replacement battery may be housed within a replacement end portion, with the same configuration as the end portion 40. It is then only necessary to secure the replacement end portion 40 to the main portion 41 to continue operation, with the replacement battery.

The battery may be sealed within a plastic housing forming the end portion 40, with only the terminals exposed. This protects the integrity of the battery.

In an alternative embodiment, the battery 46 may be removable from the housing end portion 40.

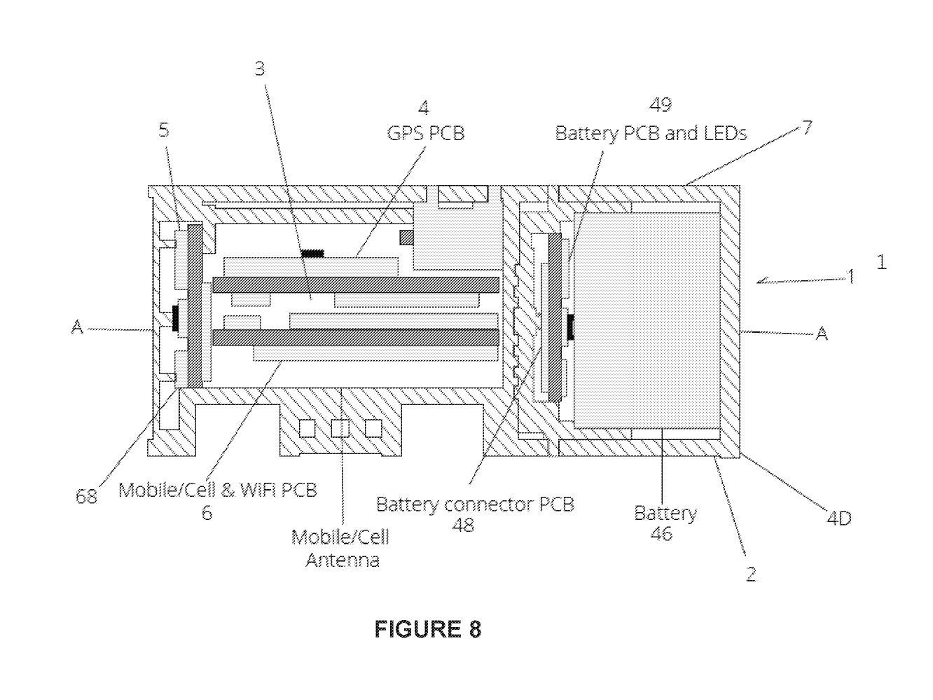

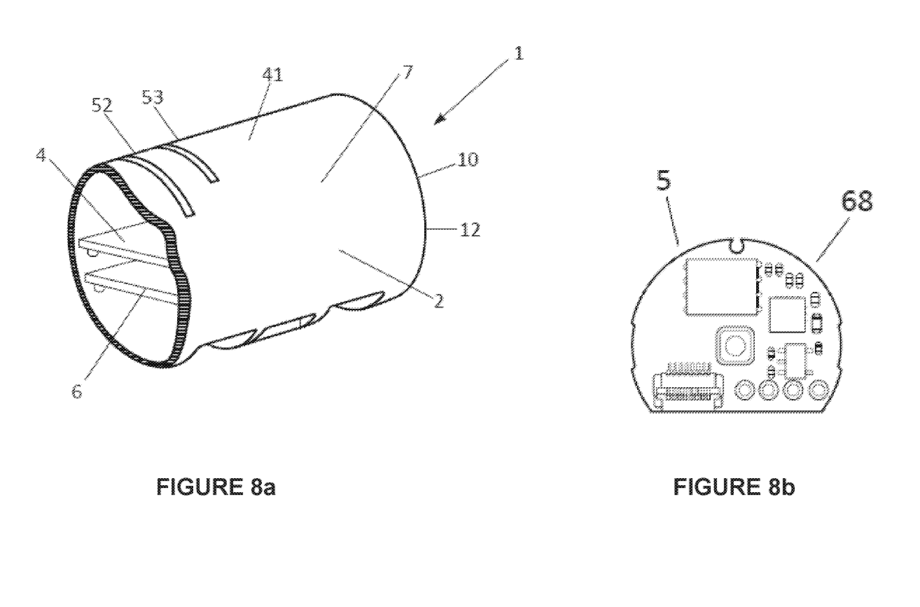

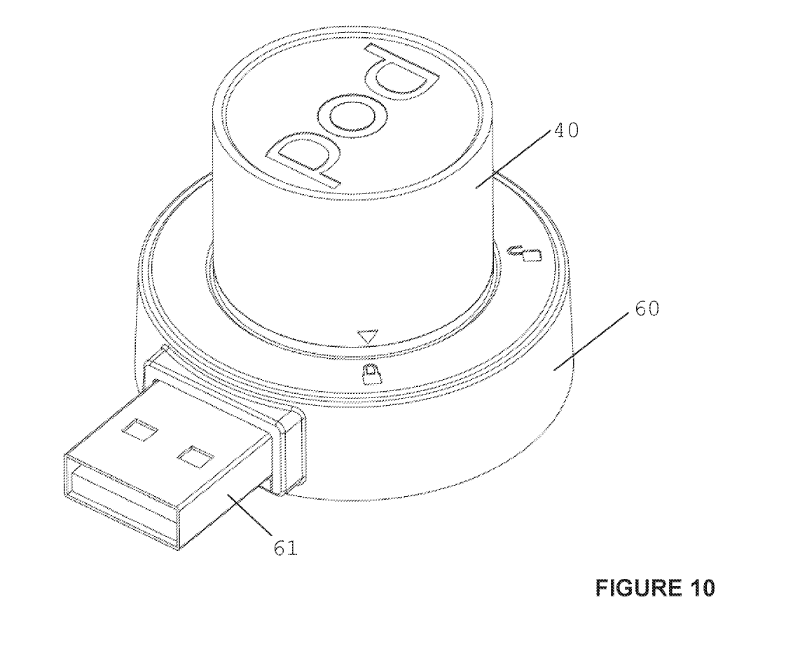

FIG. 10 shows a charging adaptor 60 for the battery 46. The USB connector 61 is used for connection to a power supply for charging of the battery 46 in housing end portion 40. A similar twist and lock arrangement to that securing the end portion 40 to the main housing portion 41 is used to secure the end portion 40 within charging port 62 of the charging adaptor 60. The charging port 62 mounts connections (not shown) for connection to the battery terminals for charging of the battery. “Lock”, “unlock” icons 63, 64 are provided to indicate when the end portion 40 is locked within charging portion 62 or unlocked. As can be seen from FIG. 8b the Bluetooth PCB 5 is a substantially circular disc, which is mounted at the end of the main housing portion 41 remote from the battery end portion 40. As can be seen from FIG. 8, the PCB 5 sides 68 abut the inside of the housing wall 7, to brace the walls. The battery connector PCB 48 and battery PCB 49 are of similar disc form to the Bluetooth PCB 5. They are mounted at the battery end of the housing 2. They also abut the inside of the housing wall 7, to brace the device.

In embodiments, the battery terminals 50 on the battery PCB 49 may connect to other power supplies than the battery 46. For example, if the item to be tracked is a motor vehicle, an external power source may be connected to the terminals 50, powering the device 1 from the car battery or generator.

The circuitry 3 is mounted within the housing 2 on a mounting structure which, in this example, comprises a plurality of circuit boards 4, 5, 6, 48, 49. The circuit boards (PCBs) are arranged within the housing 2, to maximise the use of the available space within the housing and reduce the overall size of the unit, as well as provide structural support to the housing and strengthen the device.

The Bluetooth PCB 5, and battery connector and battery PCB 48, 49, are mounted transverse to a longitudinal axis AA (FIG. 8) of the housing 2. The PCBs 5, 48, 49 act to brace the enclosure formed by the housing walls 7. The GPS PCB 4 and mobile/cell PCB 6 are placed longitudinally between the PCBs 5 and 48. As can be seen from FIG. 8a, they also extend across the inside of the housing 2 to abut the housing wall 7, providing further bracing and support.

The arrangement of this mounting structure provides a very robust structural support for the housing 7. This, together with the “barrel” shape of the device 1, provides for a very strong device. This advantageously enables the device to withstand impacts and wear, which may occur in use. The barrel shape also facilities spreading of any load on the device.

The mounting structure arrangement also optimises the use of the available space within the housing 7. The device 1 can therefore be made relatively smaller and unobtrusive, while still providing the necessary tracking functionality.

In this embodiment, there are two circuit boards arranged longitudinally and three circuit boards arranged transversely. The invention is not limited to this arrangement and number of circuit boards. There may be more or less circuit boards than illustrated, in other embodiments.

The device may be of any dimensions that are appropriate for the application. In embodiments, the device may be between 70 mm to 30 mm long and 10 mm to 30 mm wide. In an embodiment it may be between 55 mm and 45 mm long and 15 mm to 25 mm wide. In one embodiment it is 50.5 mm long and 23 mm wide.

In embodiments, the device may be made longer to receive a bigger battery (larger end portion 40) for longer battery life.

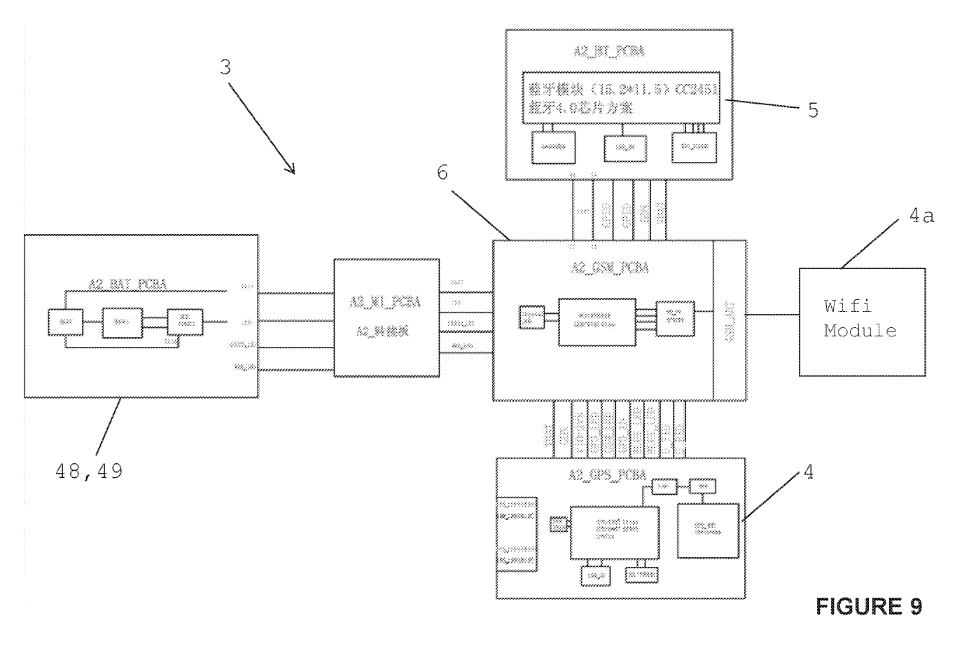

FIG. 9 is a block diagram showing the components of the device 1. These include GPS unit 4, WiFi unit 4a, Bluetooth unit 5, mobile/cell and memory unit 6 and battery and LEDs unit 49. A battery connector PCB 48 is also provided. In other embodiments, the components may be arranged in a different fashion to that of FIG. 9. Some components may be within the same chip, such as an integrated mobile/cell and GPS chip. Other circuit arrangements may be used.

The tracking device 1 is arranged to interface with a remote tracking apparatus to provide tracking information to a user. The remote apparatus is a computing device which runs computer processes. In this embodiment, the tracking apparatus comprises a computing device which runs a geo-location process which is arranged to receive the location data from the tracking device 1. The tracking apparatus comprises a processor, memory and interface. The interface presents tracking information to a user. The geo-location process processes the location data to enable identification of a geographical location of the tracking device. In this embodiment, the geo-location process interfaces with a map visualisation process to generate a map via the interface so that the user can view the geographical location of the tracking device. The location data includes time data, providing information on the time the location data was obtained. The tracking apparatus can present the geo-location information in real-time so that a user can determine where the tracking device is at the time (and hence the item being tracked).

In embodiments, the tracking apparatus may be a computer server arranged to process and generate webpages which can be accessed by other devices. It may be a standalone device, such as a PC, laptop or mobile device programmed with appropriate software applications. The tracking apparatus may implement a distributed architecture, for example, a server computer liaising with remote devices (PCs, laptops, mobile devices such as smart phones and tablets), computer processes being distributed between the server and the remote device. The tracking apparatus could implement any computing architecture.

The tracking apparatus may include programming logic which implements specific algorithms which take information from various sources of location data such as GPS, cell triangulation and WiFi locations to generate a set of map visualisations to provide a meaningful user experience based on sometimes limited location data. These may include things like showing estimated locations, recent locations and assumed locations based on user behaviour or known information about a user such as their home location.

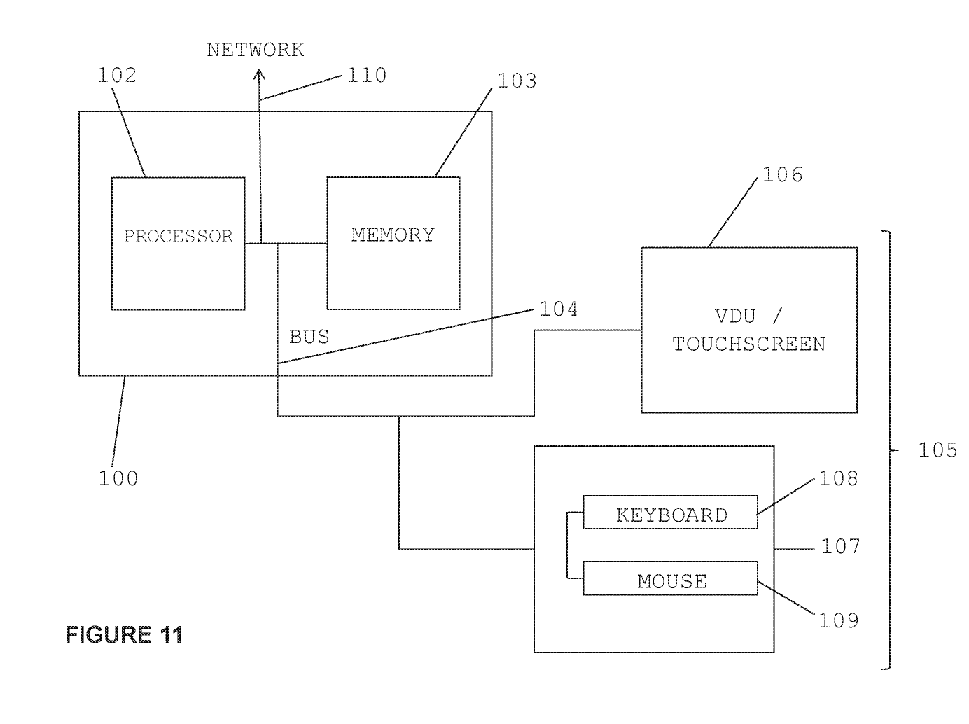

FIG. 11 illustrates a generic computing system which may implement a tracking apparatus in accordance with the present invention. The illustrated computing system comprises a computer 100 which includes a processor 102 and memory 103. The processor 102 is arranged to process program instructions and data in a known manner. Memory 103 is arranged to store program instructions and data also in a known manner. Processor 102 may constitute one or more processing means, such as integrated circuit processors. The memory 103 may comprise any known memory architecture and may include hard disk, IC memory (ROM, PROM, RAM, etc and any types of additional memories such as CD-ROM and any other type of memory.

A Bus 104 is provided for communication between the processor 102 and memory 103 and also communication with external components. In this case, the external components include a user interface 105. The user interface 105 includes a visual display unit (VDU) 106 which may also operate as a touchscreen 106. The VDU 6 may display information in graphical form or in any other form depending upon the program instructions being processed by processor 102.

The user interface 105 may also include user input means 107 which in this example includes a keyboard 108 and a mouse 109. The mouse 109 may be used to manipulate a graphical user interface (GUI). Note that the keyboard 108 and mouse 109 may be unnecessary if operation is via a touchscreen 106. A network connection 110 is also provided for connecting to a network which may include a communication network and other computing systems.

The computing system of FIG. 11 may be implemented by any known type of computing hardware, such as, for example, a PC, by a number of networked PCs if required to implement a system, by a “server architecture” or “cloud architecture” including a remote computer and user workstations connected to a remote computer, by a client/server architecture including a client computer for accessing a server computer over a network, or by any other computing architecture.

Parts of the system may be housed in the “Cloud”. This embodiment of the present invention is implemented by appropriate software providing instructions for operation of the computing system hardware to implement the tracking apparatus of the embodiment and implement the method of the embodiment. Part of the system or the entire computer system may be portable, and may be implemented, for example, by a laptop or tablet computer, or smartphone or other portable device.

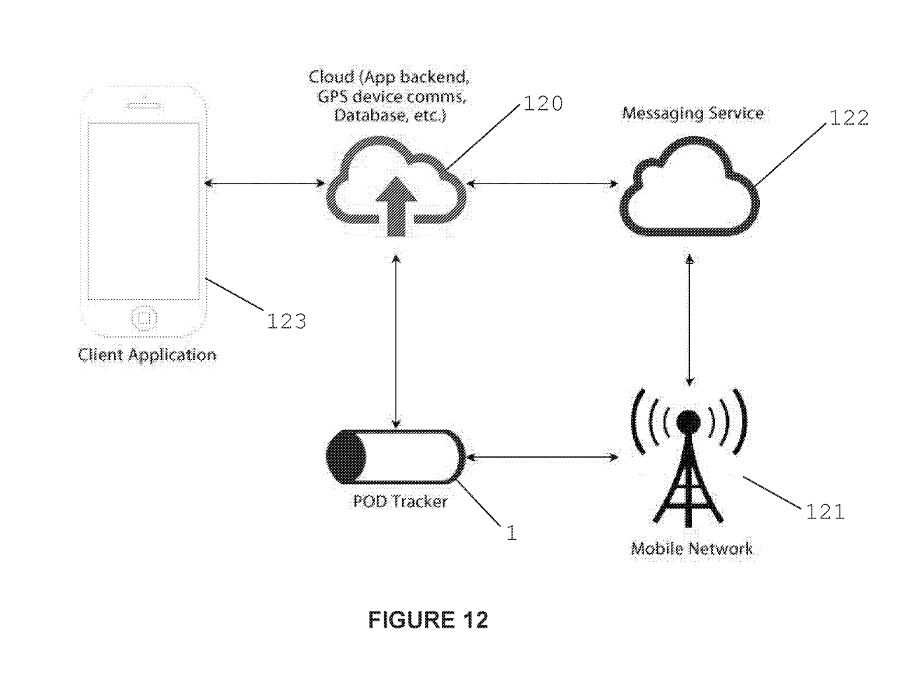

In the current embodiment, the tracking apparatus comprises a server computer system which is housed in the Cloud. See FIG. 12, reference numeral 120. The Cloud server 120 is arranged to receive signals from the device 1 and process them. The device 1 may send the signals by wireless and/or via a mobile network 121. The system also incorporates a messaging service 122 which may provide messages to the device 1 such as requesting a location and/or messages to the user based on processing of the location data from the tracking device 1.

The server 120 interfaces with a user device, in this embodiment comprising a smart phone 123 (or other mobile device). An application is provided on the user device 123. Functionality of the tracking apparatus in this embodiment is distributed between the application on the device 123 and the server system in the Cloud 120.

The server 120 may operate many tracking devices 1. The server 120 may act as a hub receiving location data from the many tracking devices. A database in the Cloud stores identifiers for the tracking devices which relate the identity of the tracking devices to particular users. One user may have more than one tracking device, tracking different items. Multiple users may also track the one item. The item being tracked may be registered on the database of the server 120. Which item is being tracked may be indicated by the application on the user device 123.

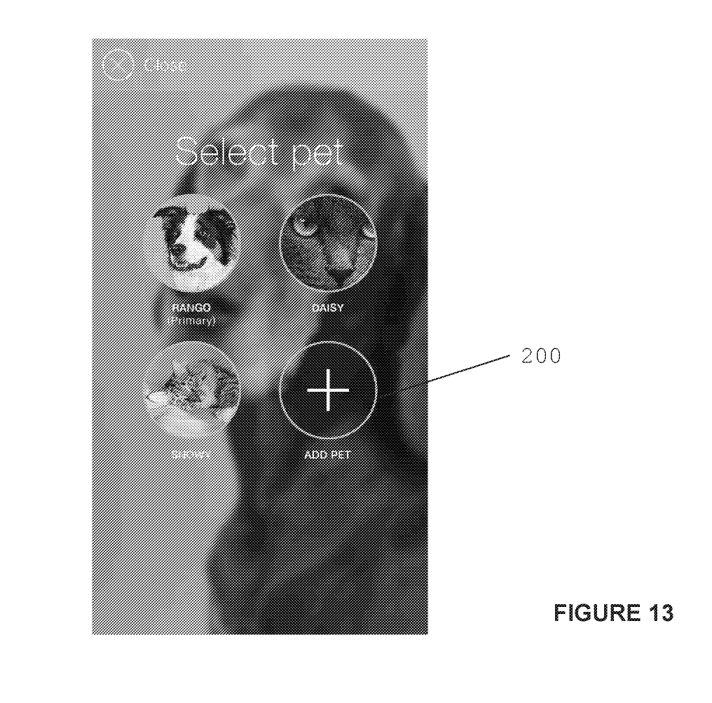

Functionality of the tracking apparatus and tracking device of this embodiment will now be described with reference to FIGS. 13 to 20. These show various “screen shots” which may be generated by the computer processors to appear on the user device 123.

FIG. 13 illustrates a screen via which a user can select an item which is being tracked, to determine tracking parameters of a particular item. In this embodiment, the tracking apparatus is set to track a number of devices (3), in this case each associated with a particular pet of the device user. The user (via the touchscreen of the device 123) may select which of the pets they require information on. A “button” 200 is provided to add an additional item to be tracked (in this case “add pet”).

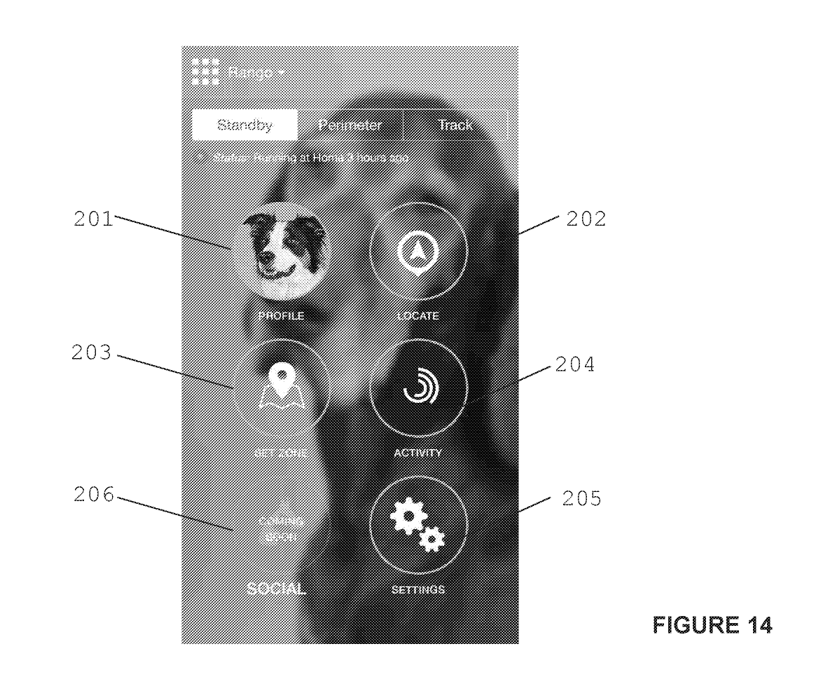

FIG. 14 illustrates a main menu for the selected pet (in this case “Rango”). The menu enables a number of options for Rango:

The button 201 enables selection of Rango's “profile”. Button 202 causes the tracking apparatus to establish the location of Rango. Button 203 enables a boundary zone to be set. Button 204 enables Rango's activity to be monitored. Button 205 enables access to settings. Button 206 enables interfacing with a social network so that information may be shared. For example, “activities” of Rango may be uploaded to social networks such as Facebook for comparison with other pets.

In this embodiment, the location data is stored in the memory on the device 1 and uploaded to the Cloud server 120 to be subsequently processed and then displayed in map format on the application on the device 123.

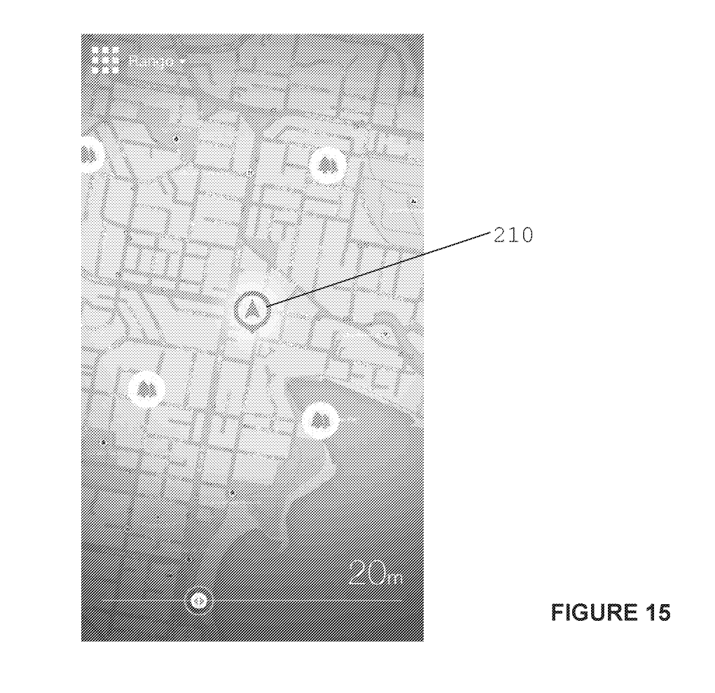

FIG. 15 shows that the geo-location process has produced a location on a map for Rango, reference numeral 210. The user is therefore presented with the real-time location of their pet. This is of significant advantage. The user can track their pet if they are lost, for example.

The map may be generated via the geo-location process interfacing with map visualisation software, such as a map API. The current position may be displayed. Further, there is an option to display a series of positions over a set period (1 hour, 1 day, 1 week).

The current location may be established by pressing the locate button 202. The display may also display the time since that location data was received, if not real-time. For example, it may display “2 hours ago” next to the location pin 210.

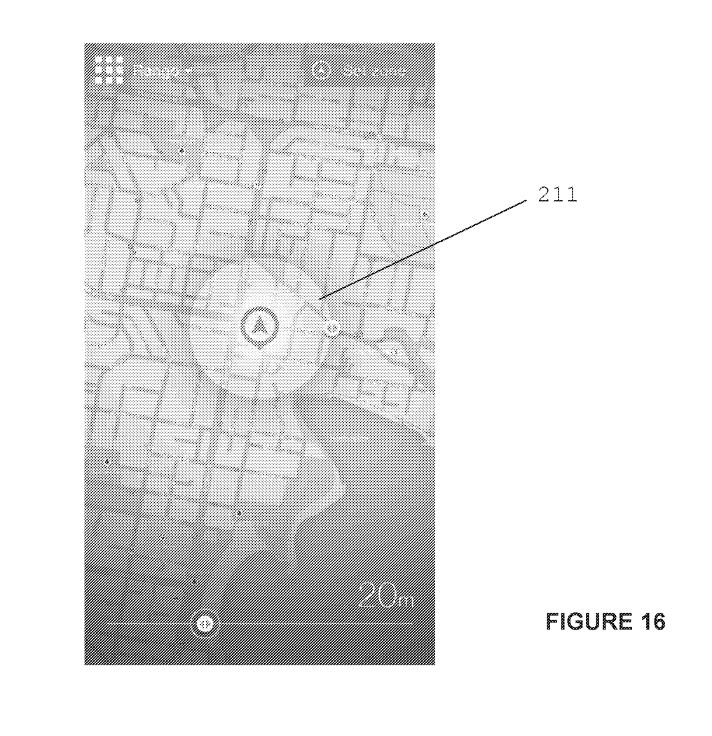

Actuating the Set Zone button 203 enables a boundary zone to be set. See FIG. 16. The boundary zone 211 may be set by operation of the touchscreen. In this embodiment the boundary zone is circular. In another embodiment, the boundary zone may be polygonal and set by touching and dragging various points on the boundary. An advantage of the ability to set a polygonal boundary, is that a boundary could be set corresponding to a designated area for the pet, such as the garden of a house, for example. A boundary monitoring process is arranged to track the location of the device and if the device moves outside the boundary an alert is generated advising the user that the boundary has been breached.

In an embodiment, the device 1 triggers a hardware based alert. Hardware based alerts require less data allowance and battery power than a software based detection of a perimeter breach as the geo-location process can be performed locally on the device.

In an embodiment, the cloud triggers a software based alert.

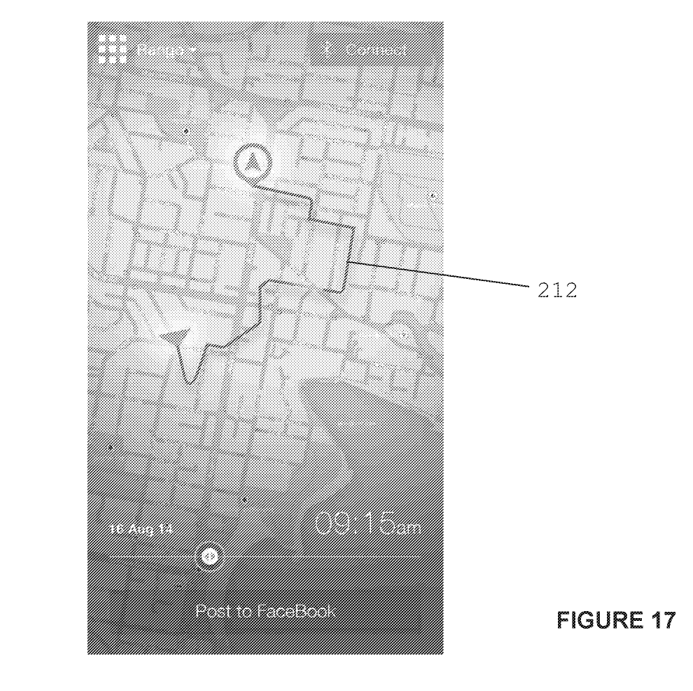

FIG. 17 illustrates the ability of a geo-location process to monitor and present motion of the tracking device over time. In this embodiment it is presented as a pathway 212, to the current location.

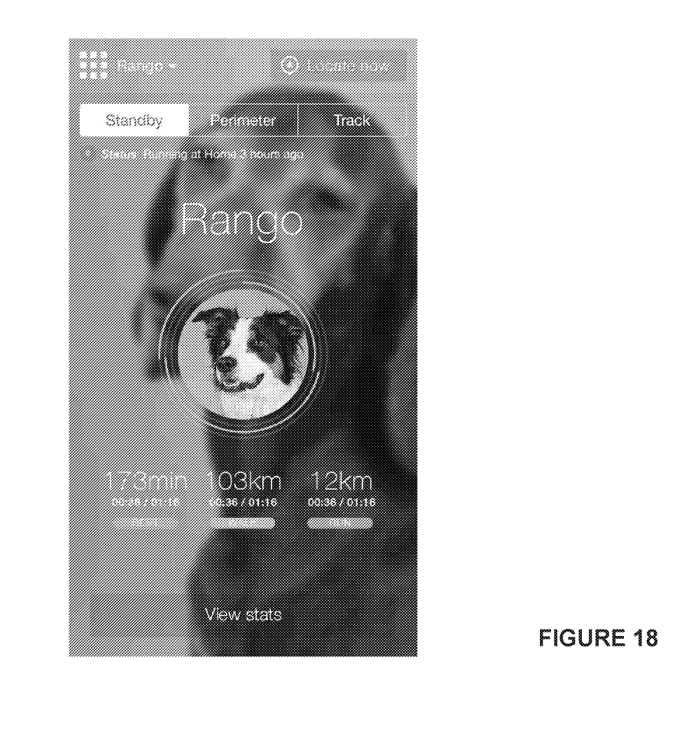

An activity tracking process is arranged to determine activity data of the tracking device. The activity data may include speed of travel, distance travelled and other activity data. See FIG. 18, which shows some stored statistics for Rango.

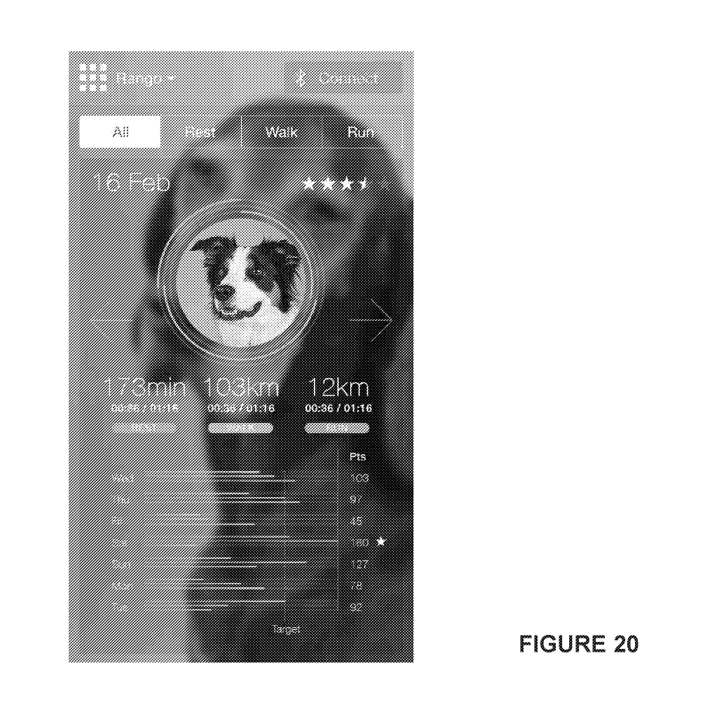

FIG. 20 shows further stored statistics for Rango, shown over a period of time (a week).

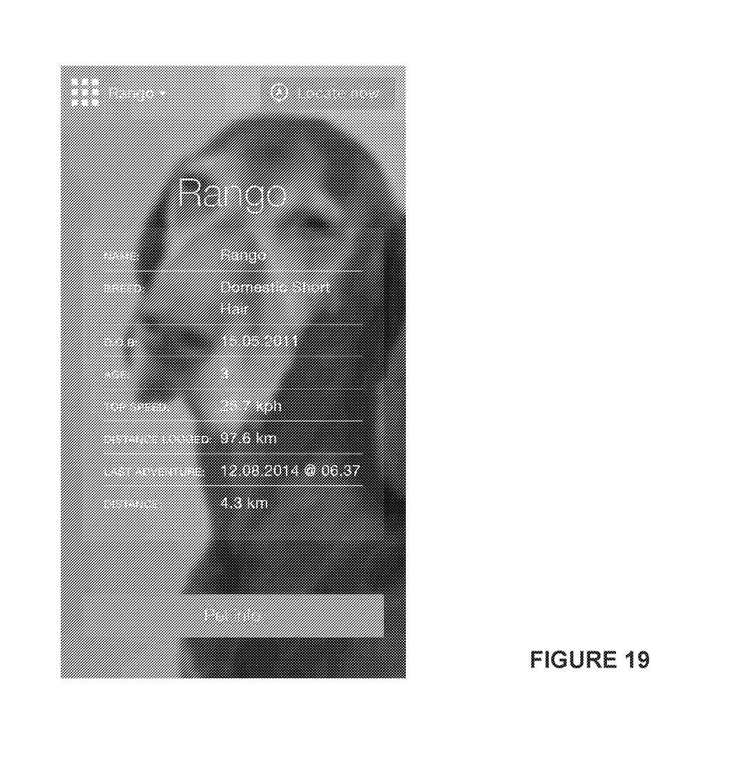

FIG. 19 shows various information on Rango which can be logged.

The ability to store motion of the tracking device over time, or and other statistics, enables the “history” of the tracking device to be monitored. This can be used in a number of circumstances. For example, if the pet has a habit of “escaping” the tracking device may show that they go to similar places each time they escape. This can be used to prevent future escape, perhaps, or quickly get the pet back because of knowledge of where they usually go (even if the tracking device should become lost).

The application has the ability to store selected adventures. For example “Bondi—12 Sep. 2014”. Statistics for a particular adventure may be presented on the user interface. The adventures may be saved on the server 120 to be posted to social media or reviewed later.

In embodiments, activity information can be played back. The user may move a slide bar on the screen or touchscreen to play back the activity on a map for the defined period. For example, sliding from left to right will move a pin along the geo-location activity line from morning to night for a one day activity view.

Activities may be posted to social media. A social network process may be provided for the apparatus which enables data to be uploaded to a social network site. The data may include activity data or any other data obtained by the tracking device and processed by the tracking apparatus.

The device sends battery level data to the server when sending other data. If a battery level is getting low, an alert can be sent to the user. If no battery data is available from the device, the application may estimate battery level of the unit, based on time.

A computer process alerts the user when the battery is estimated to be at low levels, such as 20 percent and 10 percent (which can be user defined). The alerts will also provide the current location. When the battery gets very low e.g. 1 percent it will send a final geo-location to the server and the alert will be sent to the user device saying “Rango is out of batteries. Click to see location”, or other similar message.

An accelerometer on the device produces activity data which is stored on the device and sent to the Cloud over a mobile/cell network or when the device is connected with the App e.g. via Bluetooth.

As discussed above, multiple tracking devices may be supported for one user, so that the user can manage multiple tracking devices. Further, more than one user device may manage each tracking device. For example all members of a family, could interact with a particular tracking device.

To avoid false alarms, the user has the ability to set the App to “walking mode” so that a perimeter alert won't be triggered for a period of time (user configurable), the user can then walk their pet without receiving perimeter breach alerts. If the user forgets to set the App in walking mode and a false alert is sent, a walking button on the alert message cancels the perimeter alert and sends a message to all App users saying “false alarm”.

The user can set the frequency that the device records and sends the locations in various device modes. Each setting will translate to a series of system parameters that will be supported by the device firmware. The user can choose when to start and stop parameters which will apply to each device mode and function. Default values will be set for each parameter and user specific values may also be set.

In an embodiment, the tracking apparatus may also comprise an associated device detection process which is arranged to receive data regarding an associated device. The associated device may be a further tracking device which may be being used to track another item. For example, if your pet spends time playing with other pets, the other pets tracking devices could be designated as associated tracking device(s). The device detection process can gather data on how long the tracking device is in the same vicinity as the other tracking device(s). A person can therefore establish how long their pet has been playing with another pet. Messages may be provided between the owners of the various tracking devices via their mobile devices/tracking apparatus advising that “Rango spent an hour playing with Oscar today” or similar messages.

The apparatus and device are enabled to track activity data of an item, as discussed above. Where the item is a pet, historical activity data can be monitored. It can be determined, for example, whether a dog is being regularly walked or not. In an embodiment, the tracking apparatus is arranged to provide exercise data, alerting a user as to whether their pet is getting enough exercise. This is based on the activity data statistics and an exercise process provided for the tracking apparatus. In an embodiment, exercising information may be provided as a feed from the server, so that the user can design appropriate exercise routines (the appropriate amount of walking, for example) based on the exercise data. The exercise data may advise a user of exercise requirements. For example “Rango needs to be walked six times this week, as you only walked him four times last week”.

In an embodiment, the tracking apparatus may include a diet information process, which is arranged to receive and/or generate diet information for the user, relating to dietary needs of their pet. This can be based on the profile of the pet entered into the tracking apparatus, (eg. weight, type of pet etc).

In a further embodiment of the tracking device described above, the electrical circuity 3 may include firm ware and/or software for forcing notifications on processing devices such as smart phones or other mobile computing apparatus that may be in proximity to the tracking device. For example, if a pet is lost, or the tracking device is not functioning properly so it is not in touch with the server, the tracking device may detect when a smart phone is in range and alert the smart phone to the existence of the tracking device. The smart phone may then be given the opportunity to connect with the tracking device via wireless. Information could then be uploaded from the device such as “My name is Rango and, I am lost my address is . . . ” or a phone number could be given to the device.

Forced notifications provide a fall back operation if an item is lost and cannot be tracked. Even if the item can be tracked, it may still be useful to have a forced notification facility operate.

As well as GPS or other location technologies, the tracking circuitry of the tracking device may also comprise wireless technology. This may be used to facilitate a Wi-Fi location process, enabled by triangulation as the device comes into proximity with other Wi-Fi “hot-spots”. This provides an additional location process that can be used to make the tracking device location more robust. That is, the process could be used with GPS or other mobile location technology to provide location where no GPS signal is being received or to provide a check on the accuracy of the location.

In another embodiment, the wireless circuitry could be used solely for location in the absence of other location circuitry such as GPS or mobile/cellular. This would make a more cost effective device, for example, location could be by sending a wireless message from a device such as a smartphone, computer etc. to a known Wi-Fi location. For example the known Wi-Fi could be at the owner's home or place of business. If they receive a return message from the Wi-Fi on the tracking device they are therefore notified that the tracking device is in that location. In such an embodiment, the device may not require any GPS or mobile/cellular technology or a SIM card, and such a device could be less expensive, or less expensive to operate (for example, you could operate the device without a SIM card, even if GPS or mobile/cellular technology was present).

In the above embodiment, a tracking apparatus is configured for the tracked items to be pets. It would be appreciated that the items may be any other items, and the invention is not limited to tracking pets. The tracking apparatus can be reconfigured to track any item. Items to be tracked may include pets, livestock, people e.g. children, the elderly, staff, family members. Automotive items may be tracked e.g. cars, trucks, planes, motorbikes. Equipment, machinery, construction tools, shipping, luggage, cargo, freight, yachts and boats;

military guns, personnel equipment, guard dogs, shipments. Any item may be tracked using the device apparatus of the embodiments of the present invention.

Other embodiments of the tracking device may include a camera and video recorder and images or video may be uploaded.

Embodiments may include a larger battery pack or an external power source.

It will be appreciated by persons skilled in the art that numerous variations and/or modifications may be made to the invention as shown in the specific embodiments without departing from the spirit or scope of the invention as broadly described. The present embodiments are, therefore, to be considered in all respects as illustrative and not restrictive.

1.-44. (canceled)

45. A tracking device, comprising circuitry and a housing mounting the circuitry, the circuitry comprising tracking circuitry arranged to provide location data enabling identification of a location of the tracking device, and communications circuitry arranged to communicate the location data, the housing comprising housing walls forming an enclosure, the circuitry being mounted within the enclosure, the housing walls having a curved form.

46. The device according to claim 45, wherein the housing walls form a cylindrical enclosure.

47. The device according to claim 45, wherein the housing walls comprise a mounting portion arranged for enabling mounting of the device with respect to the item to be tracked.

48. The device according to claim 47, wherein the mounting portion comprises one or more channels arranged to receive parts of a fastener for fastening a device to an item.

49. The device according to claim 48, wherein the fastener comprises a single, relatively broad strap portion.

50. The device according to claim 49, wherein the mounting portion comprises a single channel to receive the single strap portion.

51. The device according to claim 45, wherein the circuitry is mounted by a mounting structure arranged within the housing to brace the housing walls.

52. The device according to claim 51, wherein the mounting structure comprises at least one printed circuit board (PCB), positioned transversely to a longitudinal axis of the housing structure.

53. The device according to claim 52, comprising a plurality of PCBs, one or more of the PCBs being placed transversely and one or more other PCBs running longitudinally with respect to the housing.

54. The device according to claim 53, wherein one or more of the longitudinally running PCBs also extend across the inside of the housing to the housing walls, in order to structurally brace the housing.

55. The device according to claim 45, further comprising a battery mounted within the housing.

56. The device according to claim 55, wherein the battery is mounted in a housing end portion which is removable from the rest of the housing, together with the battery.

57. A device in accordance with claim 56, wherein the battery is sealed within the housing end portion, whereby to protect the integrity of the battery.

58. A device in accordance with claim 45, wherein indicators are provided on an external surface of the housing to indicate when the housing end portion and housing are secured.

59. A tracking apparatus, comprising a processor, a memory, an interface, and a geo-location process arranged to receive location data from a tracking device, and to provide geo-location information identifying the geographical location of the tracking device.

60. An apparatus in accordance with claim 59, comprising an activity tracking process, which is arranged to determine activity data of a tracking device.

61. An apparatus in accordance with claim 60, wherein the activity data comprises one of speed of travel of the tracking device and distance travelled.

62. An apparatus in accordance with claim 59, comprising a boundary monitoring process enabling setting of a perimeter.

63. An apparatus in accordance with claim 62, the boundary monitoring process being arranged to provide an alert should the perimeter be breached.

64. A tracking device, comprising circuitry and a housing mounting the circuitry, the circuitry comprising tracking circuitry arranged to provide location data enabling identification of a location of the tracking device, the tracking circuitry comprising Wi-Fi circuitry, and circuitry arranged to receive a Wi-Fi message and return a message confirming that the device is within a known Wi-Fi area, whereby to establish a location of the device.
